(19) United States
(12) Patent Application Publication
(10) Pub. No.: US 2026/0230833 A1
(43) Pub. Date: Aug. 6, 2026

(54) DEVICE AND METHOD FOR SPECTRUM MANAGEMENT

(71) Applicant: Sony Group Corporation, Tokyo (JP)

(72) Inventors: Shuo WANG, Beijing (CN); Chen SUN, Beijing (CN)

(73) Assignee: Sony Group Corporation, Tokyo (JP)

(21) Appl. No.: 19/146,535

(22) PCT Filed: Jan. 15, 2024
(86) PCT No.: PCT/CN2024/072308

§ 371 Date: Jul. 9, 2025

(30) Foreign Application Priority Data
Jan. 19, 2023 (CN) 202310096183.0

(51) Int. Cl. H04W 16/14; H04W 12/08

(52) U.S. Cl. CPC H04W 16/14; H04W 12/08

(57) ABSTRACT

The present disclosure relates to a device and a method for spectrum management. There is provided an electronic device for spectrum management in a wireless communication system, the wireless communication system includes a plurality of general authorization systems, the electronic device includes a processing circuitry configured to: receive spectrum requests from two or more general authorization systems of the plurality of general authorization systems, wherein the spectrum requests from the two or more general authorization systems are in conflict; transmit an expected spectrum efficiency reporting instruction to the two or more general authorization systems; receive expected spectrum efficiency information from the two or more general authorization systems; and transmit an authorization response including a success indication to a first general authorization system of the two or more general authorization systems with higher expected spectrum efficiency.

### CROSS-REFERENCE TO RELATED APPLICATIONS

The present application claims priority to Chinese Patent Application No. 202310096183.0 filed on Jan. 19, 2023, and entitled “DEVICE AND METHOD FOR SPECTRUM MANAGEMENT”, which is incorporated herein by reference in its entirety.

### TECHNICAL FIELD

The present disclosure relates to wireless communication, specifically, to a device and a method for spectrum management.

### BACKGROUND

With the application of 5G technology, the deployment of network base stations has become more dense, and at the same time, the number of various types of terminals such as mobile phones, Internet of Things (IoT) devices, and wearable devices has increased sharply, leading to an ever-growing demand for spectrum resources, especially frequency bands below 6 GHz that are suitable for mobile communications. Due to the heterogeneity and dynamic nature of traffics, traditional static spectrum management schemes have low spectrum utilization efficiency, resulting in a waste of precious spectrum resources.

### SUMMARY

The present disclosure provides a new technical solution for spectrum management.

According to one aspect of the present disclosure, there is provided an electronic device for spectrum management in a wireless communication system, the wireless communication system includes a plurality of general authorization systems, the electronic device includes a processing circuitry configured to: receive spectrum requests from two or more general authorization systems of the plurality of general authorization systems, wherein the spectrum requests from the two or more general authorization systems are in conflict; transmit an expected spectrum efficiency reporting instruction to the two or more general authorization systems; receive expected spectrum efficiency information from the two or more general authorization systems, wherein an expected spectrum efficiency of a first general authorization system of the two or more general authorization systems is higher than expected spectrum efficiencies of other general authorization systems of the two or more general authorization systems; and transmit an authorization response including a success indication to the first general authorization system.

According to another aspect of the present disclosure, there is provided an electronic device on a side of a first general authorization system in a wireless communication system, wherein the wireless communication system includes a plurality of general authorization systems, the plurality of general authorization systems include the first general authorization system, the electronic device includes a processing circuitry configured to: transmit a first spectrum request to a spectrum management apparatus, wherein the first spectrum request conflicts with spectrum requests from one or more other general authorization systems of the plurality of general authorization systems; receive an expected spectrum efficiency reporting instruction from the spectrum management apparatus; transmit expected spectrum efficiency information to the spectrum management apparatus; and receive a first authorization response from the spectrum management apparatus, wherein in a case where expected spectrum efficiency of the first general authorization system is higher than expected spectrum efficiencies of the one or more other general authorization systems, the first authorization response includes a success indication.

According to another aspect of the present disclosure, there is provided a method for spectrum management in a wireless communication system, the wireless communication system includes a plurality of general authorization systems, the method comprises: receive spectrum requests from two or more general authorization systems of the plurality of general authorization systems, wherein the spectrum requests from the two or more general authorization systems are in conflict; transmit an expected spectrum efficiency reporting instruction to the two or more general authorization systems; receive expected spectrum efficiency information from the two or more general authorization systems, wherein an expected spectrum efficiency of a first general authorization system of the two or more general authorization systems is higher than expected spectrum efficiencies of other general authorization systems of the two or more general authorization systems; and transmit an authorization response including a success indication to the first general authorization system.

According to another aspect of the present disclosure, there is provided a method performed by a first general authorization system in a wireless communication system, wherein the wireless communication system includes a plurality of general authorization systems, the plurality of general authorization systems include the first general authorization system, the method comprises: transmit a first spectrum request to a spectrum management apparatus, wherein the first spectrum request conflicts with spectrum requests from one or more other general authorization systems of the plurality of general authorization systems; receive an expected spectrum efficiency reporting instruction from the spectrum management apparatus; transmit expected spectrum efficiency information to the spectrum management apparatus; and receive a first authorization response from the spectrum management apparatus, wherein in a case where expected spectrum efficiency of the first general authorization system is higher than expected spectrum efficiencies of the one or more other general authorization systems, the first authorization response includes a success indication.

According to another aspect of the present disclosure, there is provided a non-transitory computer-readable storage medium with program instructions stored thereon, which when executed by a processor cause the processor to perform the method of the present disclosure.

According to another aspect of the present disclosure, there is provided a computer program product including program instructions, which when executed by a processor cause the processor to perform the method of the present disclosure.

### DRAWINGS

When the following detailed description of embodiments is considered in conjunction with the drawings, it is possible to obtain better understanding of the present disclosure. The same or similar reference numerals are used in the respective drawings to denote the same or similar components. Together with the following detailed description, the respective drawings are incorporated in and form a part of this specification, serve to exemplify embodiments of the present disclosure and explain principles and advantage of the present disclosure.

FIG. 1 is a schematic view illustrating a wireless communication system to which the technology of the present disclosure may be applied.

FIG. 2 is a flowchart illustrating a spectrum allocation flow based on expected spectrum efficiencies according to an embodiment of the present disclosure.

FIG. 3 is a flowchart illustrating a spectrum allocation flow based on waiting time according to an embodiment of the present disclosure.

FIG. 4 is a flowchart illustrating a heartbeat flow of a general authorization system that has obtained spectrum authorization according to an embodiment of the present disclosure.

FIG. 5 is a flowchart illustrating a heartbeat flow of a priority access system with a protection area according to an embodiment of the present disclosure.

FIG. 6 is a schematic view illustrating dynamic adjustment of the protection area of the priority access system according to an embodiment of the present disclosure.

FIG. 7 is a flowchart illustrating a method executed by a spectrum management apparatus according to an embodiment of the present disclosure.

FIG. 8 is a flowchart illustrating a method executed by a general authorization system according to an embodiment of the present disclosure.

FIG. 9 illustrates a communication system including SAS and CBSD according to an embodiment of the present disclosure.

FIG. 10 illustrates a communication system based on blockchain according to an embodiment of the present disclosure.

FIG. 11 is a block diagram illustrating an example of a schematic configuration of a computation device to which the technology of the present disclosure may be applied.

FIG. 12 is a block diagram illustrating a first example of a schematic configuration of a gNB to which the technology of the present disclosure may be applied.

FIG. 13 is a block diagram illustrating a second example of a schematic configuration of a gNB to which the technology of the present disclosure may be applied.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

In the relevant art, spectra can be shared among a plurality of systems for wireless communication. However, relevant dynamic spectrum allocation schemes only consider problems of interference protection for high-priority systems and interference coexistence among low-priority systems, e.g. calculation of a radio environment map (or a coverage overlap map) and spectrum allocation based on a coloring method, and do not consider the efficiency of the low-priority systems in utilizing spectrum resources.

With respect to the problem of insufficient utilization of the allocated spectrum resources in the spectrum management, the present disclosure designs a spectrum management scheme with traffic feature awareness. In some embodiments of the present disclosure, the spectrum resources are preferentially allocated to general authorization systems with higher spectrum efficiencies, which improves the utilization efficiency of the shared spectrum. When a spectrum management apparatus receives spectrum requests, from a plurality of general authorization systems, for a same channel and with conflicting usage times, it requires the general authorization systems to provide their spectrum efficiency information, and preferentially allocates the spectrum resources to the general authorization systems with higher spectrum efficiencies. In some embodiments of the present disclosure, a general authorization system that fails to obtain the spectrum resources records a time at which it first requests, and provides, a waiting time from the first request, to the spectrum management apparatus in a subsequent request, the spectrum management apparatus will in time provide available spectrum resources to a general authorization system whose waiting time exceeds a certain threshold. In some embodiments of the present disclosure, when the spectrum management apparatus calculates the available spectrum resources for the general authorization system, a protection area of a priority access system is determined based on a position of a user terminal and an actual situation of the traffic to meet a minimum protection area in which a service of the priority access system is not affected. In some embodiments of the present disclosure, in the process of being authorized to use the spectrum, the general authorization system periodically reports unused power headroom to the spectrum management apparatus, so that this power headroom may be considered in the spectrum management process.

In an embodiment of the present disclosure, the general authorization system refers to a system that has general authorization with respect to spectrum access and that does not have a higher spectrum access priority than other systems, the priority access system refers to a system that has a higher priority with respect to the spectrum access than the general authorization system.

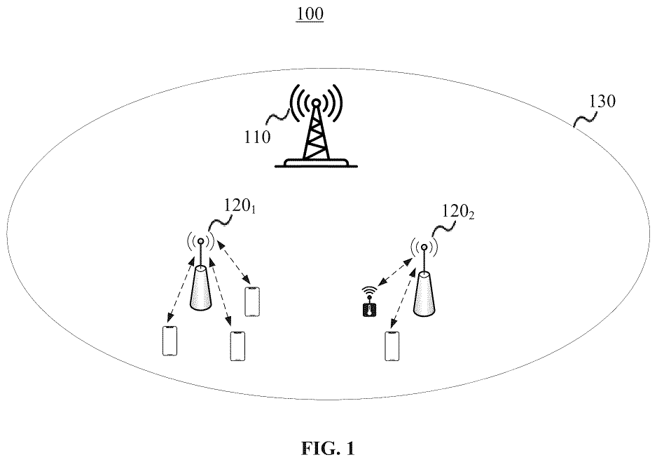

FIG. 1 is a schematic view illustrating a wireless communication system 100 to which the technology of the present disclosure may be applied. The wireless communication system 100 includes a priority access system 110 and a plurality of general authorization systems (120₁, 120₂, . . . ). Here, subscripts are used to distinguish respective general authorization systems, however, in a case where there is no need to distinguish them, a reference numeral 120 may be used to represent any one of the plurality of general authorization systems. Each of the priority access system 110 and the general authorization system 120 may include a base station and user terminals served by the base station. The priority access system 110 may have a protection area 130. Within the protection area 130, the general authorization system 120 may share the spectrum resources of the priority access system 110 without causing harmful interference to the priority access system 110. In addition, the wireless communication system 100 may further include a spectrum management apparatus (not shown) that performs available spectrum calculation and authorization.

The wireless communication system 100 may be a citizen broadband radio service (CBRS) system. There is a three-layer spectrum sharing architecture in the CBRS system, which includes an Incumbent layer, a Priority Access License (PAL) layer and a General Authorization Access (GAA) layer. The Incumbent layer has priority over the PAL layer and the GAA layer, and the PAL layer has priority over the GAA layer. The priority access system 110 in the wireless communication system 100 may be a PAL user in the CBRS system, and the general authorization system 120 in the wireless communication system 100 may be a GAA user in the CBRS system. In addition, the wireless communication system 100 may further include an incumbent user in the CBRS system.

Different general authorization systems 120 respectively serve different users, and have different traffic features. In the relevant art, when the spectrum management apparatus makes spectrum allocation decisions, it only considers a frequency and a maximum transmission power to calculate the interference. However, the general authorization system 120 does not always transmit at the maximum power, and it does not necessarily transmit data continuously, which leads to the insufficient utilization of the spectrum resources. In addition, there is also a problem of how to perform the allocation to improve the spectrum efficiency when the number of available channels is insufficient for orthogonal allocation to multiple general authorization systems. The technical solution of the present disclosure improves the spectrum utilization efficiency by preferential allocation to the general authorization systems with higher spectrum efficiencies.

A communication flow according to an embodiment of the present disclosure will be described below in conjunction with the accompanying drawings. It is noted that when the communication flows of the priority access system and the general authorization system are described, operations are generally performed by the base stations of the priority access system and the general authorization system.

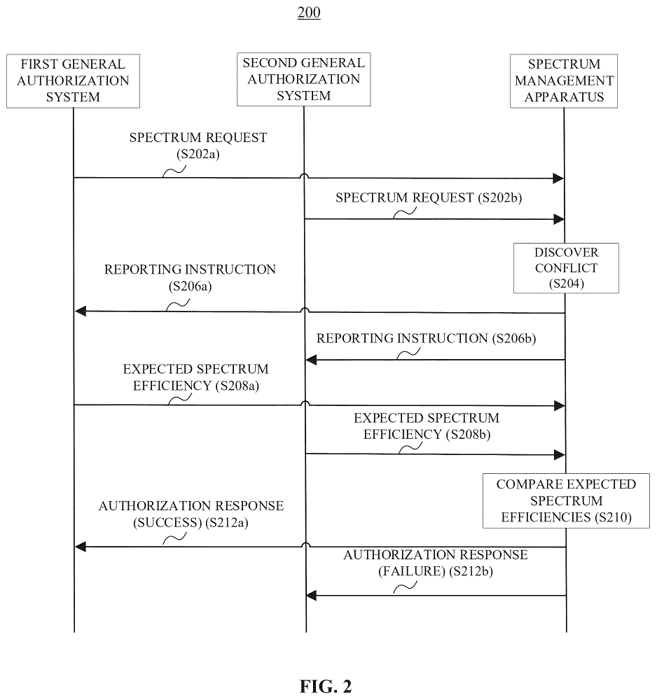

FIG. 2 is a flowchart illustrating a spectrum allocation flow 200 based on expected spectrum efficiencies according to an embodiment of the present disclosure. In the spectrum allocation flow 200, spectrum requests from a first general authorization system and a second general authorization system of a plurality of general authorization systems conflict, the spectrum management apparatus allocates the channel to a general authorization system with a higher expected spectrum efficiency, thereby improving the spectrum utilization efficiency.

In step S202a, the first general authorization system transmits a spectrum request to the spectrum management apparatus to request a spectrum from the spectrum management apparatus. The spectrum request transmitted by the first general authorization system may include an identifier of the first general authorization system, a requested spectrum range, and so on. In step S202b, the second general authorization system transmits a spectrum request to the spectrum management apparatus to request a spectrum from the spectrum management apparatus. The spectrum request transmitted by the second general authorization system may include an identifier of the second general authorization system, a requested spectrum range, and so on.

In step S204, the spectrum management apparatus discovers that there is a conflict between the spectrum request from the first general authorization system and the spectrum request from the second general authorization system. That is, the spectrum requests from the first general authorization system and the second general authorization system include the same or overlapping spectrum. There is a conflict in the time when the first general authorization system and the second general authorization system use this spectrum, so the spectrum management apparatus needs to decide which general authorization system this spectrum is to be allocated to. In an embodiment of the present disclosure, the spectrum management apparatus requires the first general authorization system and the second general authorization system that transmitted the spectrum requests to report their expected spectrum efficiencies, and allocates the spectrum to the general authorization system with a higher expected spectrum efficiency to improve the spectrum utilization efficiency.

In step S206a, the spectrum management apparatus transmits a reporting instruction to the first general authorization system, the reporting instruction may include the identifier of the first general authorization system, an expected spectrum efficiency reporting instruction, and so on. In step S206b, the spectrum management apparatus transmits a reporting instruction to the second general authorization system, the reporting instruction may include the identifier of the second general authorization system, an expected spectrum efficiency reporting instruction, and so on. In step S208a, the first general authorization system transmits the expected spectrum efficiency information, etc, to the spectrum management apparatus. In step S208b, the second general authorization system transmits the expected spectrum efficiency information, etc, to the spectrum management apparatus. The expected spectrum efficiency information may include a spectrum efficiency predicted based on historical traffic statistics or artificial intelligence. The spectrum efficiency may be, for example, a ratio of a total transmission rate to an occupied bandwidth. The spectrum efficiency of the wireless system changes dynamically, and has a certain periodicity. By utilizing the expected spectrum efficiency predicted based on historical traffic statistics or artificial intelligence, the overall spectrum utilization rate can be improved.

In step S210, the spectrum management apparatus compares the expected spectrum efficiency of the first general authorization system with that of the second general authorization system. Here, it is assumed that the spectrum management apparatus determines that the expected spectrum efficiency of the first general authorization system is higher than that of the second general authorization system. In step S212a, the spectrum management apparatus transmits an authorization response to the first general authorization system to authorize the first general authorization system to use the spectrum. The authorization response may include the identifier of the first general authorization system, a success indication, and so on. In step S212b, the spectrum management apparatus transmits an authorization response to the second general authorization system to notify the second general authorization system of the authorization failure. The authorization response may include the identifier of the second general authorization system, a failure indication, and so on.

Although only the spectrum requests from two general authorization systems are shown to conflict in FIG. 2. However, it is noted that the spectrum requests from more general authorization systems may conflict. In some implementations, the spectrum requests from these general authorization systems may all be transmitted to the spectrum management apparatus. In some implementations, the spectrum requests from one or more general authorization systems of these general authorization systems are first transmitted to a domain proxy, and then forwarded by the domain proxy to the spectrum management apparatus. In some implementations, the spectrum requests from one or more general authorization systems of these general authorization systems are transmitted to other spectrum management apparatuses, and then shared with the spectrum management apparatus by the other spectrum management apparatuses, for example, through the blockchain.

The general authorization systems that use the shared spectrum may adopt a variety of wireless standards with different spectrum efficiencies. If a large amount of resources are occupied by inefficient general authorization systems, the spectrum efficiency can not be improved. The present disclosure improves the spectrum utilization efficiency by allocating the spectrum to the general authorization systems with higher expected spectrum efficiencies.

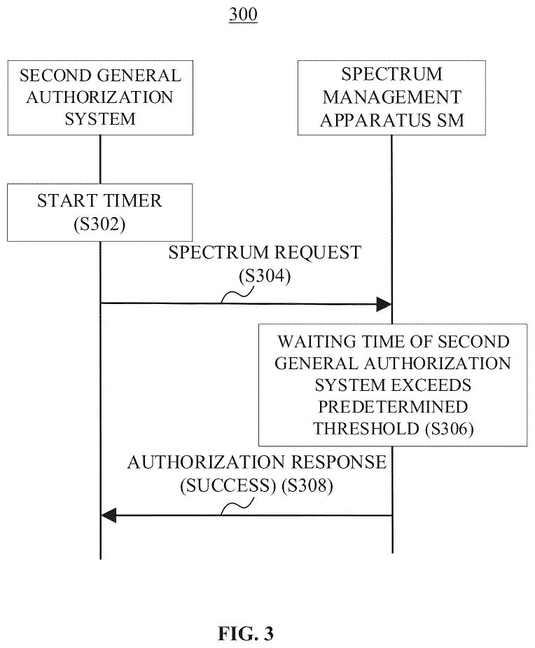

FIG. 3 is a flowchart illustrating a spectrum allocation flow 300 based on waiting time according to an embodiment of the present disclosure. In the spectrum allocation flow 300, when the spectrum management apparatus determines that the waiting time of the general authorization system since the first spectrum request fails exceeds a predetermined threshold, it allocates the channel to the general authorization system in time. This general authorization system may be, for example, the second general authorization system whose spectrum request fails in the spectrum allocation flow 200 of FIG. 2.

In step S302, the second general authorization system starts a timer in response to the failure of the first spectrum request, to clock the waiting time since the first spectrum request fails. For example, the second general authorization system starts the timer in response to the received first authorization response including a failure indication. This authorization response may be the authorization response received in the spectrum allocation flow 200 of FIG. 2. In step S304, the second general authorization system transmits a spectrum request to the spectrum management apparatus, this spectrum request may include the identifier of the second general authorization system, the requested spectrum range, the waiting time since the first spectrum request fails, and so on. In step S306, the spectrum management apparatus determines that the waiting time of the second general authorization system exceeds a predetermined threshold. In step S308, the spectrum management apparatus transmits an authorization response including a success indication to the second general authorization system to authorize the second general authorization system to use the spectrum, regardless of whether the spectrum request from the second general authorization system conflicts with the spectrum requests from one or more other general authorization systems (not shown). The authorization response may include e.g. the identifier of the second general authorization system, the success indication, and so on.

It is noted that in a case where the spectrum management apparatus determines that the waiting time of the second general authorization system does not exceed the predetermined threshold, it may not execute step S308, but instead execute steps S206 to S212 of the spectrum allocation flow 200 in FIG. 2. If the second general authorization system receives an authorization response including a success indication, it may stop the clocking of the timer. If the second general authorization system receives an authorization response including a failure indication again, it will continue the clocking of the timer.

In some embodiments of the present disclosure, the general authorization system that has obtained the spectrum authorization may periodically transmit heartbeat requests to the spectrum management apparatus.

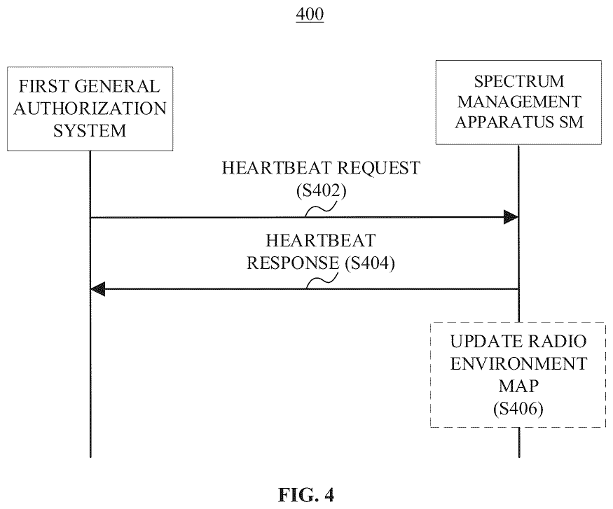

FIG. 4 is a flowchart illustrating a heartbeat flow 400 of a general authorization system that has obtained spectrum authorization according to an embodiment of the present disclosure. The general authorization system that has obtained the spectrum authorization may be, for example, the first general authorization system that has obtained the spectrum authorization in the spectrum allocation flow 200 of FIG. 2. In step S402, the first general authorization system transmits a heartbeat request to the spectrum management apparatus. This heartbeat request may include, for example, the identifier of the first general authorization system. In step S404, the spectrum management apparatus transmits a heartbeat response to the first general authorization system.

The first general authorization system that has obtained the spectrum authorization may not always operate at the permitted maximum transmission power, thus wasting a certain portion of resources. In some embodiments of the present disclosure, in the process of the first general authorization system that has obtained the spectrum authorization using the spectrum, it may include power headroom information in the heartbeat requests transmitted periodically to the spectrum management apparatus, so as to indicate its unused power headroom. Therefore, the spectrum management apparatus may provide the unused power headroom of the first general authorization system to other general authorization systems that need it. The spectrum management apparatus may update the radio environment map (or coverage overlap map) based on the power headroom information in step S406. After updating the radio environment map (or coverage overlap map), the spectrum management apparatus may perform spectrum management based on the updated radio environment map (or coverage overlap map).

In the relevant technical solutions, the maximum permitted transmission power of each general authorization system is used to calculate the interference, and a lower limit of the available spectrum is obtained, thereby the spectrum resources are not effectively utilized. The technical solution of the present disclosure can obtain a more actual radio environment map (or coverage overlap map), thus enabling more efficient utilization of the spectrum resources.

In addition, the actual spectrum efficiency of the first general authorization system that has obtained the spectrum authorization will change dynamically. In some embodiments of the present disclosure, in the process of the first general authorization system that has obtained the spectrum authorization using the spectrum, it may include actual spectrum efficiency information in the heartbeat requests transmitted periodically to the spectrum management apparatus. The spectrum management apparatus may compare the actual spectrum efficiency of the first general authorization system with the expected spectrum efficiency reported when the spectrum was requested. When the actual spectrum efficiency is lower than the expected spectrum efficiency by a predetermined percentage, the heartbeat request transmitted from the spectrum management apparatus to the first general authorization system includes, for example, an indication of bandwidth reduction or an indication of suspending spectrum use. Therefore, the spectrum management apparatus may monitor the actual spectrum efficiency of the first general authorization system that has obtained the spectrum authorization and make corresponding adjustments.

In some embodiments of the present disclosure, the priority access system with a protection area may also periodically transmit heartbeat requests to the spectrum management apparatus.

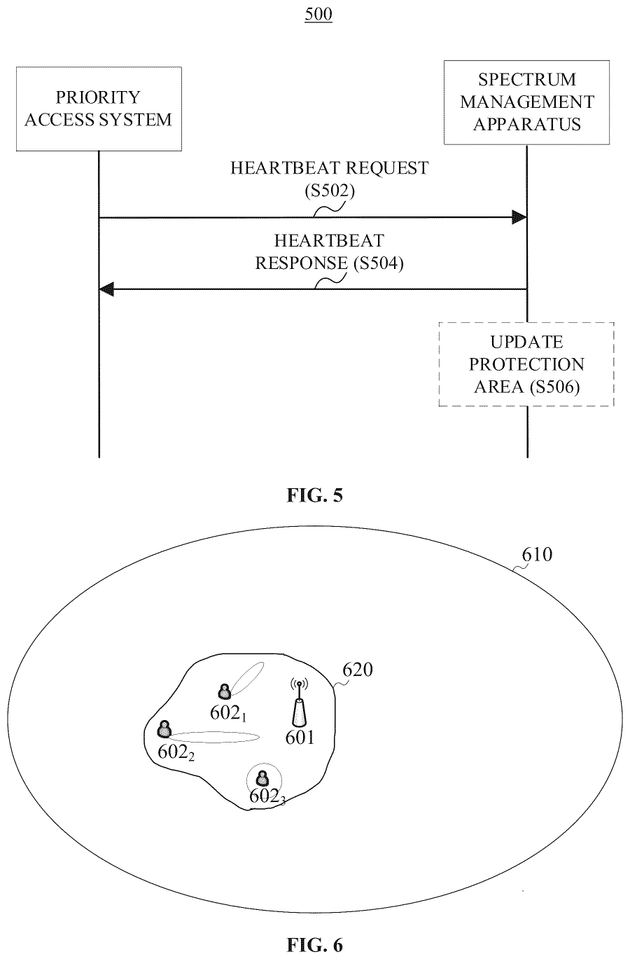

FIG. 5 is a flowchart illustrating a heartbeat flow 500 of a priority access system with a protection area according to an embodiment of the present disclosure. In step S502, the priority access system transmits a heartbeat request to the spectrum management apparatus. This heartbeat request may include, for example, an identifier of the priority access system. In step S504, the spectrum management apparatus transmits a heartbeat response to the priority access system.

In some embodiments of the present disclosure, the heartbeat request periodically transmitted by the priority access system may include contour information of the protection area, so as to dynamically adjust the range of the protection area. In some implementations, the contour information of the protection area may be, for example, the information of vertices defining a boundary of the protection area. In some implementations, the contour information of the protection area may be, for example, the information of azimuth angles and distances that define the boundary of the protection area.

In the relevant art, the range of the protection area is calculated based on the interference power within the coverage of the priority access system not exceeding a protection threshold of −96 dBm/10 MHz. The range of spectrum sharing will be limited due to the excessive protection of the priority access system. On the one hand, the embodiments of the present disclosure enable the priority access system to reduce the range of the protection area according to movement trajectories of user terminals that it actually serves, so that general authorization systems outside the protection area can access the spectrum more flexibly. The priority access system may collect statistics of or predict a movement range of the user terminals according to position information reported by the user terminals. On the other hand, the embodiments of the present disclosure enable the priority access system to reduce the range of the protection area according to actual QoS requirements of the user terminals that it actually serves, so that it is sufficient to ensure the service quality of the user terminals being served. A tolerable interference level is determined according to the QoS requirements of the user terminals. For example, the current requirement for the interference protection threshold of the protection area is −80 dBm/10 MHz, and when the QoS requirement of the user terminal is lower, a higher interference level can be tolerated, e.g. −75 dBm/10 MHz, the general authorization system sharing this segment of the spectrum may increase the corresponding transmission power. The contour of the protection area may be determined according to either or both of the above two factors. When the contour of the protection area changes, the priority access system will transmit the contour information of the dynamically adjusted protection area to the spectrum management apparatus through the heartbeat request.

FIG. 6 is a schematic view illustrating dynamic adjustment of the protection area of the priority access system according to an embodiment of the present disclosure. The priority access system includes a base station 601 and a plurality of user terminals (602₁, 602₂, 602₃, . . . ) served by the base station 601. Here, subscripts are used to distinguish respective user terminals, however, in a case where there is no need to distinguish them, a reference numeral 602 may be used to represent any one of the plurality of user terminals. If the range of the protection area of the priority access system is calculated according to the protection threshold of −96 dBm/10 MHz, a fixed protection area 610 may be obtained.

The embodiments of the present disclosure propose dynamically adjusting the range of the protection area in the case of considering the actual position and/or the QoS requirement of each user terminal 602, so as to obtain a dynamic protection area 620. In some implementations, the dynamic protection area 620 may be a minimum range that covers the movement trajectory (a curve accompanying the user terminal 602 as shown in FIG. 6) of each user terminal 602 served by the priority access system. In some implementations, the dynamic protection area 620 may be a range determined according to an interference level corresponding to the QoS requirement of the user terminal 602 served by the priority access system. In some implementations, the dynamic protection area 620 may be a union of the minimum range that covers the movement trajectory of the user terminal 602 served by the priority access system and the range determined according to the interference level corresponding to the QoS of the user terminal 602 served by the priority access system. The range of the dynamic protection area 620 is smaller than that of the fixed protection area 610, which enables general authorization systems outside the protection area to access the spectrum more flexibly.

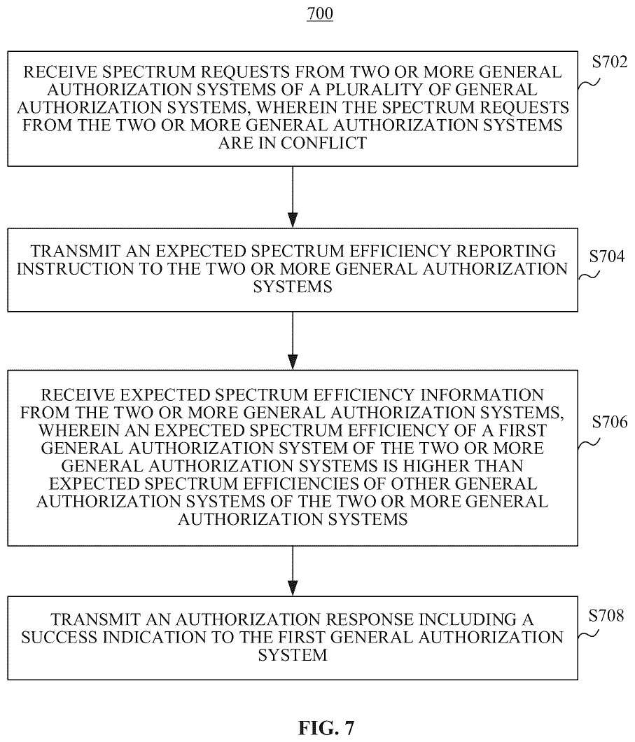

FIG. 7 is a flowchart illustrating a method 700 executed by a spectrum management apparatus according to an embodiment of the present disclosure. In step S702, the spectrum management apparatus receives spectrum requests from two or more general authorization systems of a plurality of general authorization systems, wherein the spectrum requests from the two or more general authorization systems are in conflict. In step S704, the spectrum management apparatus transmits an expected spectrum efficiency reporting instruction to the two or more general authorization systems. In step S706, the spectrum management apparatus receives expected spectrum efficiency information from the two or more general authorization systems, wherein an expected spectrum efficiency of a first general authorization system of the two or more general authorization systems is higher than expected spectrum efficiencies of other general authorization systems of the two or more general authorization systems. In step S708, the spectrum management apparatus transmits an authorization response including a success indication to the first general authorization system. In addition, the method 700 may also include any of the steps performed by the spectrum management apparatus as described above with reference to FIGS. 2 to 5.

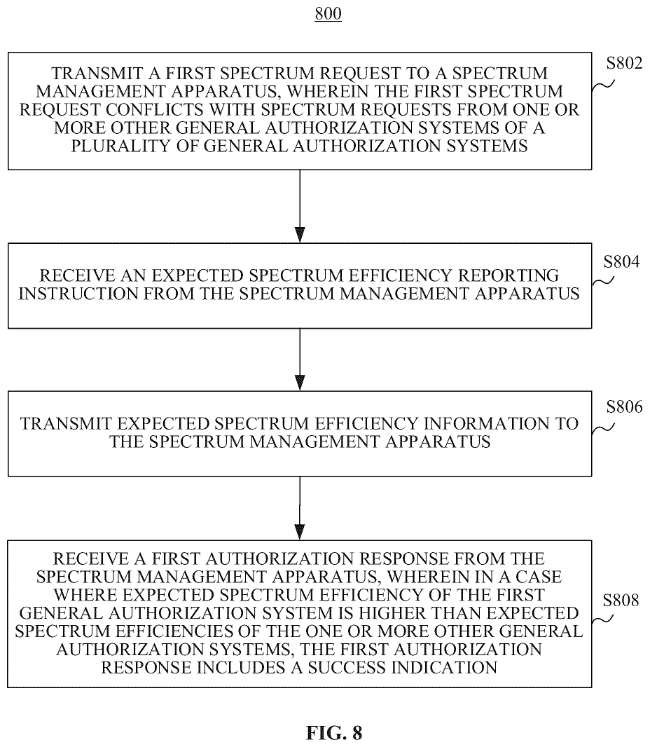

FIG. 8 is a flowchart illustrating a method 800 executed by a general authorization system according to an embodiment of the present disclosure. In step S802, the general authorization system transmits a first spectrum request to a spectrum management apparatus, wherein the first spectrum request conflicts with spectrum requests from one or more other general authorization systems of a plurality of general authorization systems. In step S804, the general authorization system receives an expected spectrum efficiency reporting instruction from the spectrum management apparatus. In step S806, the general authorization system transmits expected spectrum efficiency information to the spectrum management apparatus. In step S808, the general authorization system receives a first authorization response from the spectrum management apparatus, wherein in a case where expected spectrum efficiency of the first general authorization system is higher than expected spectrum efficiencies of the one or more other general authorization systems, the first authorization response includes a success indication. In addition, the method 800 may also include any of the steps performed by the general authorization system as described above with reference to FIGS. 2 to 5.

In some embodiments of the present disclosure, the spectrum management apparatus may be deployed centrally in a cloud. For example, the spectrum management apparatus in the embodiments of the present disclosure may be implemented as a Spectrum Access Service (SAS) entity in CBRS, and the priority access system and the general authorization system may be implemented as CBRS Devices (CBSDs), specifically as a Priority Access License (PAL) device and a General Authorized Access (GAA) device respectively.

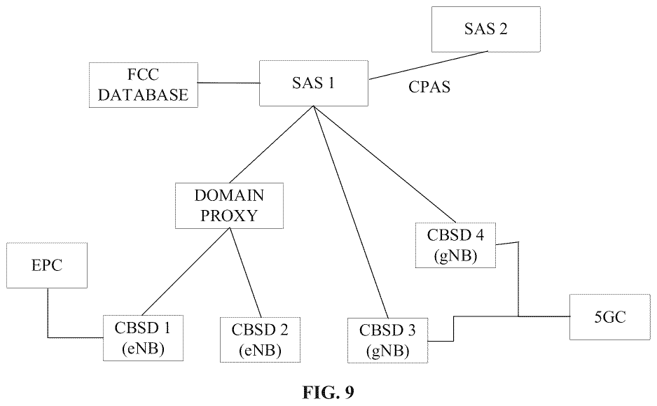

FIG. 9 illustrates a communication system 900 including SAS and CBSD according to an embodiment of the present disclosure. The interaction between SAS and SAS may be realized through a Collaborative Periodic Activities (CPAS) process between SASs. For example, the CPAS process may be executed periodically once every 24 hours. CBSD may interact with SAS directly or through a domain proxy. CBSD may adopt different radio access technologies, such as LTE or 5G.

In some embodiments of the present disclosure, the spectrum management apparatus may be distributed based on blockchain technology.

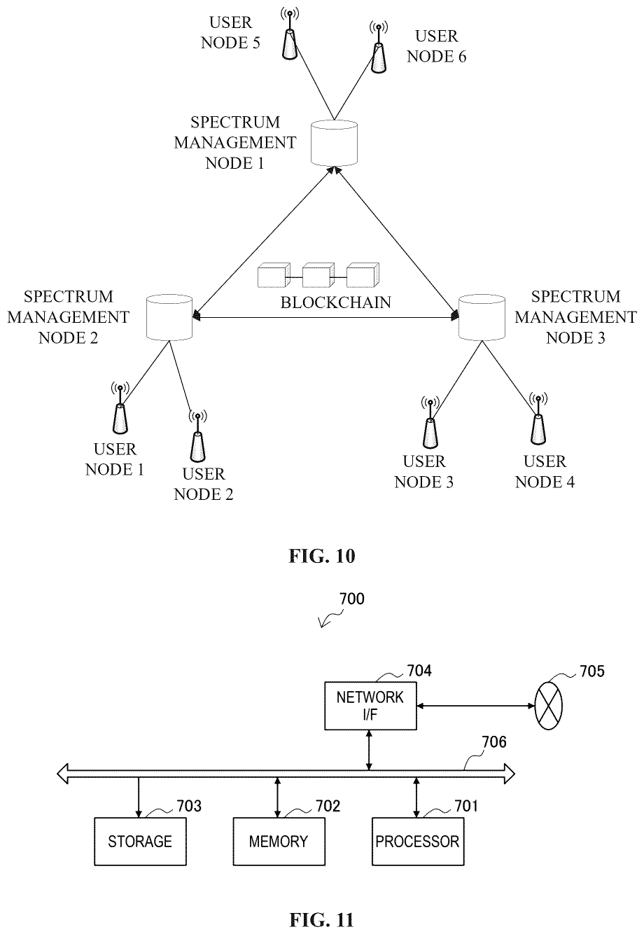

FIG. 10 illustrates a communication system 1000 based on blockchain according to an embodiment of the present disclosure. A plurality of spectrum management nodes form a blockchain network, all spectrum allocation information is recorded in the form of a blockchain in respective spectrum management nodes of the blockchain network, the blockchain may adopt a consortium blockchain to improve the transaction processing speed. The priority access system and the general authorization system are implemented as user nodes, the information that they transmit to the spectrum management nodes needs to be broadcasted to the entire blockchain network through a P2P network formed by the spectrum management nodes, and is recorded in a blockchain ledger of each spectrum management node through a consensus mechanism.

### Application Examples

The technology of the present disclosure can be applied to various products. A base station may be implemented as various types of computation devices, or it may be implemented as any type of evolved Node B (eNB), gNB, or TRP (Transmit Receive Point), such as a macro eNB/gNB and a small eNB/gNB. A small eNB/gNB may be an eNB/gNB that covers a cell smaller than a macro cell, such as a pico eNB/gNB, a micro eNB/gNB, and a home (femto) eNB/gNB. Instead, the base station may be implemented as any other types of base stations such as a NodeB and a base transceiver station (BTS). The base station may include a main body (also referred to as a base station device) configured to control wireless communication and one or more remote radio heads (RRHs) disposed at different locations from the main body. Additionally, various types of terminals to be discussed later may also operate as the base station by temporarily or semi-permanently executing a base station function.

FIG. 11 is a block diagram illustrating an example of a schematic configuration of a computation device 700 to which the technology of the present disclosure may be applied. The computation device 700 includes a processor 701, a memory 702, a storage 703, a network interface 704, and a bus 706.

The processor 701 may be, for example, a central processing unit (CPU) or a digital signal processor (DSP) and controls functions of the server 700. The memory 702 includes a random access memory (RAM) and a read only memory (ROM) and stores data and programs executed by the processor 701. The storage 703 may include a storage medium such as a semiconductor memory or a hard disk.

The network interface 704 is a wired communication interface for connecting the server 700 to a wired communication network 705. The wired communication network 705 may be a core network such as an evolved packet core (EPC) or a packet data network (PDN) such as the Internet.

The bus 706 connects the processor 701, the memory 702, the storage 703, and the network interface 704 to each other. The bus 706 may include two or more buses that operate at different speeds (e.g., a high-speed bus and a low-speed bus).

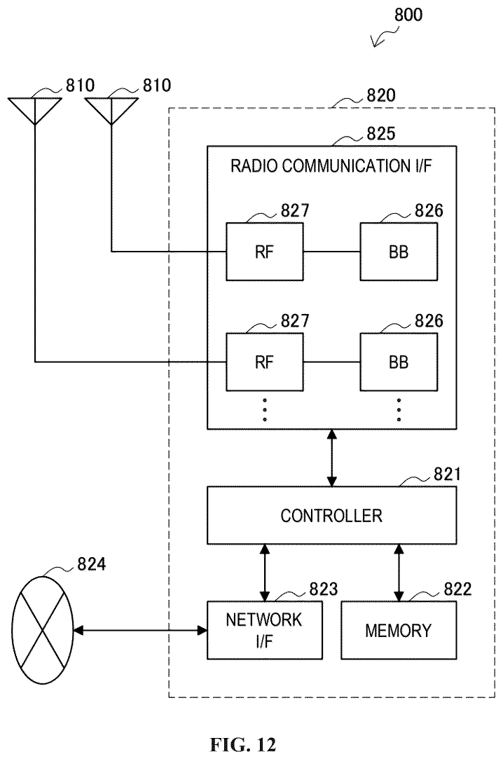

FIG. 12 is a block diagram illustrating a first example of a schematic configuration of a gNB to which the technology of the present disclosure may be applied. A gNB 800 includes one or more antennas 810 as well as a base station device 820. The base station device 820 and each antenna 810 may be connected to each other via an RF cable.

Each of the antennas 810 includes a single or multiple antenna elements (such as multiple antenna elements included in an multiple input multiple output (MIMO) antenna), and is used for the base station device 820 to transmit and receive wireless signals. The gNB 800 may include the multiple antennas 810, as illustrated in FIG. 12. For example, the multiple antennas 810 may be compatible with multiple frequency bands used by the gNB 800. Although FIG. 12 illustrates the example in which the gNB 800 includes the multiple antennas 810, the gNB 800 may also include a single antenna 810.

The base station device 820 includes a controller 821, a memory 822, a network interface 823, and a wireless communication interface 825.

The controller 821 may be, for example, a CPU or a DSP, and operates various functions of a higher layer of the base station device 820. For example, the controller 821 generates a data packet from data in signals processed by the wireless communication interface 825, and transfers the generated packet via the network interface 823. The controller 821 may bundle data from multiple base band processors to generate the bundled packet, and transfer the generated bundled packet. The controller 821 may have logical functions of performing control such as radio resource control, radio bearer control, mobility management, admission control, and scheduling. The control may be performed in corporation with an gNB or a core network node in the vicinity. The memory 822 includes RAM and ROM, and stores a program that is executed by the controller 821, and various types of control data (such as a terminal list, transmission power data, and scheduling data).

The network interface 823 is a communication interface for connecting the base station device 820 to a core network 824. The controller 821 may communicate with a core network node or another gNB via the network interface 823. In that case, the gNB 800, and the core network node or the other gNB may be connected to each other through a logical interface (such as an S1 interface and an X2 interface). The network interface 823 may also be a wired communication interface or a wireless communication interface for radio backhaul. If the network interface 823 is a wireless communication interface, the network interface 823 may use a higher frequency band for wireless communication than a frequency band used by the wireless communication interface 825.

The wireless communication interface 825 supports any cellular communication scheme such as Long Term Evolution (LTE) and LTE-Advanced, and provides radio connection to a terminal positioned in a cell of the gNB 800 via the antenna 810. The wireless communication interface 825 may typically include, for example, a baseband (BB) processor 826 and an RF circuit 827. The BB processor 826 may perform, for example, encoding/decoding, modulating/demodulating, and multiplexing/demultiplexing, and performs various types of signal processing of layers (such as L1, medium access control (MAC), radio link control (RLC), and a packet data convergence protocol (PDCP)). The BB processor 826 may have a part or all of the above-described logical functions instead of the controller 821. The BB processor 826 may be a memory that stores a communication control program, or a module that includes a processor and a related circuit configured to execute the program. Updating the program may allow the functions of the BB processor 826 to be changed. The module may be a card or a blade that is inserted into a slot of the base station device 820. Alternatively, the module may also be a chip that is mounted on the card or the blade. Meanwhile, the RF circuit 827 may include, for example, a mixer, a filter, and an amplifier, and transmits and receives wireless signals via the antenna 810.

The wireless communication interface 825 may include the multiple BB processors 826, as illustrated in FIG. 12. For example, the multiple BB processors 826 may be compatible with multiple frequency bands used by the gNB 800. The wireless communication interface 825 may include the multiple RF circuits 827, as illustrated in FIG. 12. For example, the multiple RF circuits 827 may be compatible with multiple antenna elements. Although FIG. 12 illustrates the example in which the wireless communication interface 825 includes the multiple BB processors 826 and the multiple RF circuits 827, the wireless communication interface 825 may also include a single BB processor 826 or a single RF circuit 827.

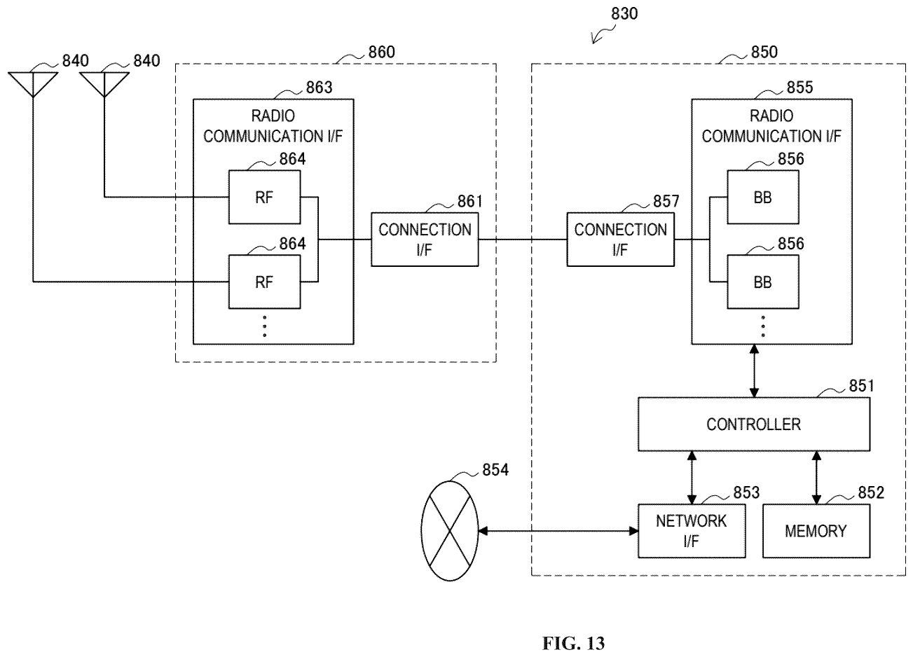

FIG. 13 is a block diagram illustrating a second example of a schematic configuration of a gNB to which the technology of the present disclosure may be applied. A gNB 830 includes one or more antennas 840, a base station device 850 and RRH 860. The RRH 860 and each antenna 840 may be connected to each other via an RF cable. The base station device 850 and the RRH 860 may be connected to each other via a high speed line such as an optical fiber cable.

Each of the antennas 840 includes a single or multiple antenna elements (such as multiple antenna elements included in an MIMO antenna) and is used for the RRH 860 to transmit and receive wireless signals. The gNB 830 may include the multiple antennas 840, as illustrated in FIG. 13. For example, the multiple antennas 840 may be compatible with multiple frequency bands used by the gNB 830. Although FIG. 13 illustrates the example in which the gNB 830 includes the multiple antennas 840, the gNB 830 may also include a single antenna 840.

The base station device 850 includes a controller 851, a memory 852, a network interface 853, a wireless communication interface 855, and a connection interface 857. The controller 851, the memory 852, and the network interface 853 are the same as the controller 821, the memory 822, and the network interface 823 described with reference to FIG. 12.

The wireless communication interface 855 supports any cellular communication scheme such as LTE and LTE-Advanced, and provides wireless communication to a terminal positioned in a sector corresponding to the RRH 860 via the RRH 860 and the antenna 840. The wireless communication interface 855 may typically include, for example, a BB processor 856. The BB processor 856 is the same as the BB processor 826 described with reference to FIG. 12, except the BB processor 856 is connected to the RF circuit 864 of the RRH 860 via the connection interface 857. The wireless communication interface 855 may include the multiple BB processors 856, as illustrated in FIG. 13. For example, the multiple BB processors 856 may be compatible with multiple frequency bands used by the gNB 830. Although FIG. 13 illustrates the example in which the wireless communication interface 855 includes the multiple BB processors 856, the wireless communication interface 855 may also include a single BB processor 856.

The connection interface 857 is an interface for connecting the base station device 850 (wireless communication interface 855) to the RRH 860. The connection interface 857 may also be a communication module for communication in the above-described high speed line that connects the base station device 850 (wireless communication interface 855) to the RRH 860.

The RRH 860 includes a connection interface 861 and a wireless communication interface 863.

The connection interface 861 is an interface for connecting the RRH 860 (wireless communication interface 863) to the base station device 850. The connection interface 861 may also be a communication module for communication in the above-described high speed line.

The wireless communication interface 863 transmits and receives wireless signals via the antenna 840. The wireless communication interface 863 may typically include, for example, the RF circuit 864. The RF circuit 864 may include, for example, a mixer, a filter, and an amplifier, and transmits and receives wireless signals via the antenna 840. The wireless communication interface 863 may include multiple RF circuits 864, as illustrated in FIG. 13. For example, the multiple RF circuits 864 may support multiple antenna elements. Although FIG. 13 illustrates the example in which the wireless communication interface 863 includes the multiple RF circuits 864, the wireless communication interface 863 may also include a single RF circuit 864.

Various schematic blocks and components described in conjunction with the present disclosure may be implemented or executed by general-purpose processors, digit signal processors (DSPs), ASICs, FPGAs or other programmable logic devices, discrete gates or transistor logics, discrete hardware components or any combination thereof, which are designed to execute functions described herein. The general-purpose processor may be a microprocessor, but instead, the processor may be any conventional processor, controller, microcontroller and/or state machine. The processor may also be implemented as a combination of computation devices, e.g. a DSP and a microprocessor, a plurality of microprocessors, one or more microprocessors in conjunction with a DSP core and/or any other combinations of such configurations.

Functions described herein may be implemented in hardware, software executed by a processor, firmware or any combination thereof. If implemented in software executed by the processor, the functions may be stored on a non-transitory computer-readable medium or transmitted as one or more instructions or codes on a non-transitory computer-readable medium. Other examples and implementations are within the scope and spirit of the present disclosure and the appended claims. For example, in view of the essence of software, the above described functions may be executed by using software executed by the processor, hardware, firmware, hard-wire or any combination of these. Feature to achieve the functions may also be located in various positions physically, including being distributed such that parts of the functions are implemented in different physical positions.

In addition, disclosure of a component which is contained in other components or separated from other components should be deemed to be exemplary, because potentially it is possible to implement various other architectures to achieve the same function, including incorporating all, a major part of, and/or some elements as one or more single structures or a part of a separate structure.

The non-transitory computer-readable medium may be any usable non-transitory medium which can be accessed by a general-purpose computer or a special-purpose computer. By way of example, and not limitation, the non-transitory computer-readable media may comprise RAM, ROM, EEPROM, flash memory, CD-ROM, DVD or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor.

The foregoing description of the present disclosure is provided to enable those skilled in the art to make or use the present disclosure. Various modifications to the present disclosure are obvious to those skilled in the art, general principles defined herein may be applied to other modifications without departing from the scope the present disclosure. Therefore, the present disclosure is not limited to examples and designs described herein, but corresponds to the broadest scope consistent with the disclosed principles and new features.

In an embodiment of the present disclosure, the processing in the base station and/or the user device may be executed by itself or components thereof (for example, such as an electronic device of a chip). The electronic device may include a processing circuitry. The processing circuitry may output a signal (digital or analog) to other components in the base station and/or the user device, may also receive a signal (digital or analog) from other components in the base station and/or the user device. In addition, the processing circuitry may also control a part or all of operations of other components in the base station and/or the user device.

The processing circuitry may be in the form of a general-purpose processor, may also be a special-purpose processing circuitry, e.g. ASIC. For example, the processing circuitry can be configured by circuitry (hardware) or a central processing device (such as, a Central Processing Unit (CPU)). In addition, the processing circuitry may bear program (software) for causing the circuitry (hardware) or the central processing device to work. The program can be stored in a memory (such as, arranged in a distributed node and/or the central processing apparatus or the electronic device) or an external storage medium externally connected, or downloaded via a network (such as, Internet).

The present disclosure further includes embodiments as follows.
Embodiment 1. An electronic device for spectrum management in a wireless communication system, the wireless communication system including a plurality of general authorization systems, the electronic device including a processing circuitry configured to:
receive spectrum requests from two or more general authorization systems of the plurality of general authorization systems, wherein the spectrum requests from the two or more general authorization systems are in conflict;
transmit an expected spectrum efficiency reporting instruction to the two or more general authorization systems;
receive expected spectrum efficiency information from the two or more general authorization systems, wherein an expected spectrum efficiency of a first general authorization system of the two or more general authorization systems is higher than expected spectrum efficiencies of other general authorization systems of the two or more general authorization systems; and
transmit an authorization response including a success indication to the first general authorization system.
Embodiment 2. The electronic device of embodiment 1, wherein the expected spectrum efficiency information includes a spectrum efficiency predicted based on historical traffic statistics or artificial intelligence.
Embodiment 3. The electronic device of embodiment 1, wherein the processing circuitry is further configured to transmit an authorization response including a failure indication to the other general authorization systems of the two or more general authorization systems.
Embodiment 4. The electronic device of embodiment 3, wherein the processing circuitry is further configured to:
receive a second spectrum request from a second general authorization system of the other general authorization systems, wherein the second spectrum request includes a waiting time from receiving the authorization response including the failure indication; and
transmit an authorization response including a success indication to the second general authorization system in response to the waiting time exceeding a predetermined threshold, regardless of whether the second spectrum request conflicts with a spectrum request from at least one general authorization system of the plurality of general authorization systems.
Embodiment 5. The electronic device of embodiment 1, wherein the processing circuitry is further configured to:
receive power headroom information from the first general authorization system, wherein the power headroom information includes unused power headroom of the first general authorization system.
Embodiment 6. The electronic device of embodiment 5, wherein the processing circuitry is further configured to:
update a radio environment map based on the power headroom information; and
perform the spectrum management based on the updated radio environment map.
Embodiment 7. The electronic device of embodiment 1, wherein the processing circuitry is further configured to:
receive an actual spectrum efficiency report from the first general authorization system; and
transmit an indication of bandwidth reduction or an indication of suspending spectrum use to the first general authorization system, when an actual spectrum efficiency of the first general authorization system is lower than the expected spectrum efficiency of the first general authorization system by a predetermined percentage.
Embodiment 8. The electronic device of embodiment 1, wherein the wireless communication system further comprises a priority access system, and the processing circuitry is further configured to:
receive protection area information from the priority access system, wherein the protection area information includes a minimum protection range determined based on at least one of an actual position and an QoS requirement of a user terminal served by the priority access system; and
perform the spectrum management based on the protection area information.
Embodiment 9. The electronic device of embodiment 1, wherein the electronic device is deployed centrally in a cloud, or distributed based on blockchain technology.
Embodiment 10. The electronic device of embodiment 1, wherein the wireless communication system is a citizen broadband radio service system, and the general authorization system is a general authorization access user.
Embodiment 11. An electronic device on a side of a first general authorization system in a wireless communication system, wherein the wireless communication system includes a plurality of general authorization systems, the plurality of general authorization systems include the first general authorization system, the electronic device includes a processing circuitry configured to:
transmit a first spectrum request to a spectrum management apparatus, wherein the first spectrum request conflicts with spectrum requests from one or more other general authorization systems of the plurality of general authorization systems;
receive an expected spectrum efficiency reporting instruction from the spectrum management apparatus;
transmit expected spectrum efficiency information to the spectrum management apparatus; and
receive a first authorization response from the spectrum management apparatus, wherein in a case where expected spectrum efficiency of the first general authorization system is higher than expected spectrum efficiencies of the one or more other general authorization systems, the first authorization response includes a success indication.
Embodiment 12. The electronic device of embodiment 11, wherein the expected spectrum efficiency information includes a spectrum efficiency predicted based on historical traffic statistics or artificial intelligence.
Embodiment 13. The electronic device of embodiment 11, wherein in a case where the expected spectrum efficiency of the first general authorization system is lower than expected spectrum efficiency of one of the one or more other general authorization systems, the first authorization response includes a failure indication.
Embodiment 14. The electronic device of embodiment 13, wherein the processing circuitry is further configured to:
transmit a second spectrum request to the spectrum management apparatus in response to the first authorization response including the failure indication, wherein the second spectrum request includes a waiting time from the first spectrum request, the second spectrum request conflicts with the spectrum requests from the one or more other general authorization systems of the plurality of general authorization systems; and
receive a second authorization response from the spectrum management apparatus, wherein in a case where the waiting time exceeds a predetermine threshold, the second authorization response includes a success indication.
Embodiment 15. The electronic device of embodiment 11, wherein the processing circuitry is further configured to:
transmit power headroom information to the spectrum management apparatus in response to the first authorization response including the success indication, wherein the power headroom information includes unused power headroom of the first general authorization system.
Embodiment 16. The electronic device of embodiment 11, wherein the processing circuitry is further configured to:
transmit an actual spectrum efficiency report to the spectrum management apparatus in response to the first authorization response including the success indication; and
in a case where the actual spectrum efficiency is lower than the expected spectrum efficiency by a predetermined percentage, receive an indication of bandwidth reduction or an indication of suspending spectrum use from the spectrum management apparatus.
Embodiment 17. The electronic device of embodiment 11, wherein the wireless communication system is a citizen broadband radio service system, and the general authorization system is a general authorization access user.
Embodiment 18. A method for spectrum management in a wireless communication system, the wireless communication system including a plurality of general authorization systems, the method comprising:
receive spectrum requests from two or more general authorization systems of the plurality of general authorization systems, wherein the spectrum requests from the two or more general authorization systems are in conflict;
transmit an expected spectrum efficiency reporting instruction to the two or more general authorization systems;
receive expected spectrum efficiency information from the two or more general authorization systems, wherein an expected spectrum efficiency of a first general authorization system of the two or more general authorization systems is higher than expected spectrum efficiencies of other general authorization systems of the two or more general authorization systems; and
transmit an authorization response including a success indication to the first general authorization system.
Embodiment 19. A method performed by a first general authorization system in a wireless communication system, wherein the wireless communication system includes a plurality of general authorization systems, the plurality of general authorization systems include the first general authorization system, the method comprising:
transmit a first spectrum request to a spectrum management apparatus, wherein the first spectrum request conflicts with spectrum requests from one or more other general authorization systems of the plurality of general authorization systems;
receive an expected spectrum efficiency reporting instruction from the spectrum management apparatus;
transmit expected spectrum efficiency information to the spectrum management apparatus; and
receive a first authorization response from the spectrum management apparatus, wherein in a case where expected spectrum efficiency of the first general authorization system is higher than expected spectrum efficiencies of the one or more other general authorization systems, the first authorization response includes a success indication.
Embodiment 20. A non-transitory computer-readable storage medium with program instructions stored thereon, which when executed by a processor cause the processor to perform the method of embodiments 18 or 19.
Embodiment 21. A computer program product including program instructions, which when executed by a processor cause the processor to perform the method of claims 18 or 19.

1. An electronic device for spectrum management in a wireless communication system, the wireless communication system including a plurality of general authorization systems, the electronic device including a processing circuitry configured to:
receive spectrum requests from two or more general authorization systems of the plurality of general authorization systems, wherein the spectrum requests from the two or more general authorization systems are in conflict;
transmit an expected spectrum efficiency reporting instruction to the two or more general authorization systems;
receive expected spectrum efficiency information from the two or more general authorization systems, wherein an expected spectrum efficiency of a first general authorization system of the two or more general authorization systems is higher than expected spectrum efficiencies of other general authorization systems of the two or more general authorization systems; and
transmit an authorization response including a success indication to the first general authorization system.

2. The electronic device of claim 1, wherein the expected spectrum efficiency information includes a spectrum efficiency predicted based on historical traffic statistics or artificial intelligence.

3. The electronic device of claim 1, wherein the processing circuitry is further configured to transmit an authorization response including a failure indication to the other general authorization systems of the two or more general authorization systems.

4. The electronic device of claim 3, wherein the processing circuitry is further configured to:
receive a second spectrum request from a second general authorization system of the other general authorization systems, wherein the second spectrum request includes a waiting time from receiving the authorization response including the failure indication; and
transmit an authorization response including a success indication to the second general authorization system in response to the waiting time exceeding a predetermined threshold, regardless of whether the second spectrum request conflicts with a spectrum request from another general authorization system of the plurality of general authorization systems.

5. The electronic device of claim 1, wherein the processing circuitry is further configured to:
receive power headroom information from the first general authorization system, wherein the power headroom information includes unused power headroom of the first general authorization system.

6. The electronic device of claim 5, wherein the processing circuitry is further configured to:
update a radio environment map based on the power headroom information; and
perform the spectrum management based on the updated radio environment map.

7. The electronic device of claim 1, wherein the processing circuitry is further configured to:
receive an actual spectrum efficiency report from the first general authorization system; and
transmit an indication of bandwidth reduction or an indication of suspending spectrum use to the first general authorization system, when an actual spectrum efficiency of the first general authorization system is lower than the expected spectrum efficiency of the first general authorization system by a predetermined percentage.

8. The electronic device of claim 1, wherein the wireless communication system further comprises a priority access system, and the processing circuitry is further configured to:
receive protection area information from the priority access system, wherein the protection area information includes a minimum protection range determined based on at least one of an actual position and an QoS requirement of a user terminal served by the priority access system; and
perform the spectrum management based on the protection area information.

9. The electronic device of claim 1, wherein the electronic device is deployed centrally in a cloud, or distributed based on blockchain technology.

10. The electronic device of claim 1, wherein the wireless communication system is a citizen broadband radio service system, and the general authorization system is a general authorization access user.

11. An electronic device on a side of a first general authorization system in a wireless communication system, wherein the wireless communication system includes a plurality of general authorization systems, the plurality of general authorization systems include the first general authorization system, the electronic device includes a processing circuitry configured to:
transmit a first spectrum request to a spectrum management apparatus, wherein the first spectrum request conflicts with spectrum requests from one or more other general authorization systems of the plurality of general authorization systems;
receive an expected spectrum efficiency reporting instruction from the spectrum management apparatus;
transmit expected spectrum efficiency information to the spectrum management apparatus; and
receive a first authorization response from the spectrum management apparatus, wherein in a case where expected spectrum efficiency of the first general authorization system is higher than expected spectrum efficiencies of the one or more other general authorization systems, the first authorization response includes a success indication.

12. The electronic device of claim 11, wherein the expected spectrum efficiency information includes a spectrum efficiency predicted based on historical traffic statistics or artificial intelligence.

13. The electronic device of claim 11, wherein in a case where the expected spectrum efficiency of the first general authorization system is lower than expected spectrum efficiency of one of the one or more other general authorization systems, the first authorization response includes a failure indication.

14. The electronic apparatus of claim 13, wherein the processing circuitry is further configured to:
transmit a second spectrum request to the spectrum management apparatus in response to the first authorization response including the failure indication, wherein the second spectrum request includes a waiting time from the first spectrum request, the second spectrum request conflicts with the spectrum requests from the one or more other general authorization systems of the plurality of general authorization systems; and
receive a second authorization response from the spectrum management apparatus, wherein in a case where the waiting time exceeds a predetermine threshold, the second authorization response includes a success indication.

15. The electronic device of claim 11, wherein the processing circuitry is further configured to:
transmit power headroom information to the spectrum management apparatus in response to the first authorization response including the success indication, wherein the power headroom information includes unused power headroom of the first general authorization system.

16. The electronic device of claim 11, wherein the processing circuitry is further configured to:
transmit an actual spectrum efficiency report to the spectrum management apparatus in response to the first authorization response including the success indication; and
in a case where actual spectrum efficiency is lower than the expected spectrum efficiency by a predetermined percentage, receive an indication of bandwidth reduction or an indication of suspending spectrum use from the spectrum management apparatus.

17. The electronic device of claim 11, wherein the wireless communication system is a citizen broadband radio service system, and the general authorization system is a general authorization access user.

18. A method for spectrum management in a wireless communication system, the wireless communication system including a plurality of general authorization systems, the method comprising:
receive spectrum requests from two or more general authorization systems of the plurality of general authorization systems, wherein the spectrum requests from the two or more general authorization systems are in conflict;
transmit an expected spectrum efficiency reporting instruction to the two or more general authorization systems;
receive expected spectrum efficiency information from the two or more general authorization systems, wherein an expected spectrum efficiency of a first general authorization system of the two or more general authorization systems is higher than expected spectrum efficiencies of other general authorization systems of the two or more general authorization systems; and
transmit an authorization response including a success indication to the first general authorization system.

19.-21. (canceled)
